(19) United States
(12) Patent Application Publication
(10) Pub. No.: US 2008/0012750 A1
(43) Pub. Date: Jan. 17, 2008

(54) DIRECTIONAL ALIGNMENT AND ALIGNMENT MONITORING SYSTEMS FOR DIRECTIONAL AND OMNI-DIRECTIONAL ANTENNAS BASED ON SOLAR POSITIONING ALONE OR WITH ELECTRONIC LEVEL SENSING

(76) Inventors: Robert Wayne Austin, Huntsville, AL (US); Gregory A. Mercier, Madison, AL (US); Bruce Weddendorf, Huntsville, AL (US)

Correspondence Address: Ralph A. Dowell of DOWELL & DOWELL P.C., 2111 Eisenhower Ave, Suite 406, Alexandria, VA, 22314, US

(21) Appl. No.: 11/768,117

(22) Filed: Jun. 25, 2007

Related U.S. Application Data
(60) Provisional application No. 60/817,415, filed on Jun. 30, 2006.

(51) Int. Cl. H01Q 1/00

(52) U.S. Cl. 342/52

(57) ABSTRACT

Alignment monitoring systems for directional and omni-directional antennas that are mounted to the antennas and which include solar sensors that are mounted with enclosing housings such that solar imaging across the surface of one or more sensing elements is used to determine a current alignment of the antennas in at least in one of headings, or azimuths of the antennas, or tilt angles thereof relative to a horizontal plane, and wherein signals generated by the sensing elements are communicated to data processing units.

### BACKGROUND OF THE INVENTION

1. Field of the Invention

The present invention relates to the field of directional alignment and alignment monitoring systems for directional and planar pattern omni-directional antennas of all types and particularly to those used in communications. Alignment of directional antennas is important in competitive industries with customers expecting uninterrupted cellular phone service and other communication and data services.

2. Description of the Related Art

Several types of metrological equipment are currently used to align directional antennas. These include conventional construction tools such as levels and transits plus location aides positioned at a distance from the antennas at known headings or locations, determined by such devices including compasses and surveying equipment or satellite global positioning systems (GPS), which can be used to site the antennas using lasers, transits and other optical equipment available to a ground observer. All these methods, however, require a technician, or teams of technicians, to climb to the height of the antennas, which are normally mounted a high elevations on towers or poles, to physically and actively align the antennas and measure their position directly by hand. No devices are currently known that can be remotely controlled to monitor antenna alignment after installation.

Hands on alignment of antennas is a significant cost to the owners of directional and omni-directional antennas and accurate alignment information is crucial when relating to overall radio frequency (RF) system design and function. Currently, there is no all inclusive method to double check the audits of antenna alignments made by tower crews. Further, each time a storm hits an area or customers complain about poor service, a crew of technicians must climb a tower or pole to manually check the alignment of the antenna. The measurements are complex and made in a difficult environment high above the ground. If a mistake is made, there is no way to verify the alignment directly. The only method available is to make a survey or study of the area the antenna is supposed to be covering using radio test equipment and comparing measured signal strengths to expected values. This method is indirect as factors other than alignment may affect signal strength.

Several articles and/papers that will provide reference and technical background relating to the present invention are: “The Impacts of Antenna Azimuth and Tilt Installation Accuracy on UMTS Network Performance” by Esmael Dinan, Ph.D. and Aleksey A. Kurochkin (January 2006), “Impact of Mechanical Antenna Downtilt on Performance of WCDMA Cellular Network” by Jamo Niemela and Jukka Lempiainen, and “Coded aperture camera imaging concept” by Jean in't Zand (1996). These articles are intended to be part of the specification to provide definitions and explanations for the technical terminology used to describe the invention. Accordingly, the three articles are hereby incorporated by reference within the specification of the present application for patent.

### SUMMARY OF THE INVENTION

The present invention is directed to directional alignment and alignment monitoring systems for directional or omni-directional antennas based on solar position alone or in combination with electronic level sensing. The invention uses sensors that mount to the antennas that are to be aligned and/or monitored and which communicate with a central data collection or processing unit. The sensors are directly mounted to antennas so as to frequently monitor their position to thereby ensure long term alignment and making it possible for the owners of the antennas to check antenna alignments and track the history of the alignments on an on going basis without having to send technicians to an antenna site to climb an antenna pole or tower to manually check the alignment.

The sensors are specifically design to monitor solar positioning during periods of day light in order to accurately determine the tilt angle of an antenna, that is the angle below a horizontal plane, and heading or azimuth, the direction of the antennas energy signals. In accordance with a first embodiment of the invention, a sensor is fixedly mounted to an antenna and includes a mask housing which entirely encloses at least one solar sensing element, such as a CCD, in order to prevent light to pass there through. To monitor solar positioning, predetermined patterns of small openings are made through a side wall of the housing such that patterns of light images will be directed onto a surface of the at least one CCD. An output signal from the at least one CCD is connected to, or is otherwise communicated to, a data processing unit where the signals received are used together with known positional location of the antenna, the time of day and the day of the year, in order to calculate the alignment data for the antenna. This information may be continuously updated and forwarded to personnel monitoring the condition of the antenna.

In another embodiment of the invention, the sensor mounted to the antenna includes at least one solar sensing element, such as a phototransistor, that is mounted within an enclosing housing that prevents light from entering but that includes at least one elongated open slit there through which is specifically configured to allow light to pass to at least one phototransistor where the detected light is used to generate signals that are communicated to the data processing unit. In some variations of this embodiment, a plurality of phototransistors may be spaced in predetermine relationships to receive solar energy at different times of day or at different angles or to receive solar energy passing through different slits.

In yet a further embodiment of the invention, a plurality of solar sensors, such as phototransistors, are placed within an enclosing housing having at least a portion of the walls transparent to permit solar light to be used to create shadow images as the light shines on a shadow creating member or post within the housing thereby casting shadow images on one or more of the phototransistors. The detected pattern of shadow images may be used to determine solar positioning by a data processor that is in communication with the solar sensors. In a preferred variation, the phototransistors are arranged in a circular pattern with the shadow creating member positioned at the center of the circle. In the current embodiment, the housing may also include a refracting lens to direct and/or concentrate light relative to the shadow creating member and the phototransistors. Further in this embodiment as well as the previous embodiments, one or more conventional electronic level detectors or accelerometers may be mounted to or adjacent the housing to measure the current tilt level of the antenna to which the sensor device is secured such that signals with respect to the tilt angle may be sent to the data processing unit.

The present invention frequently checks the alignment of an antenna automatically. No personnel must climb a tower or pole to physically take measurements to align an antenna and no personnel need be in the area of the antenna to check alignment. Alignment is checked independently of signal strength, which can eliminate a source of antenna malfunction when attempting to solve a service problem. No extra cost is incurred to make frequent measurements using the invention, as all the measurements are made automatically. The invention may also be programmed to automatically alert the antenna owners to an out of alignment condition, relieving the antenna owners of maintaining a scheduled check of alignment.

### BRIEF DESCRIPTION OF THE DRAWINGS

A better understanding of the invention will be had with reference to the accompanying drawings wherein;

FIG. 1 is an illustrational view of a plurality of alignment sensors of the present invention mounted on an array of three directional antennas;

FIG. 2 is an illustrational view showing the antennas of FIG. 1 mounted to a tower and showing a connection between the alignment sensors for the antennas and a central data collection and processing unit;

FIG. 3 is a perspective view of a first embodiment of solar alignment sensor in accordance with the invention wherein the sensor includes a coded apertured mask with one horizontal CCD mounted within the mask housing;

FIG. 4 is a view of the coded aperture mask sensor of FIG. 3 showing three vertical CCDs mounted within the mask housing;

FIG. 5 is a perspective view of a second embodiment of solar alignment sensor that includes a slit body housing with phototransistors mounted therein;

FIG. 6 is a perspective view of a variation of the solar sensor of FIG. 5;

FIG. 7 is a perspective cross sectional view of one of the slit body sensors of FIGS. 5 and 6 showing the internal phototransistors;

FIG. 8 is a perspective view of a third embodiment of solar alignment sensor in accordance with the teachings of the present invention showing a lens housing mounted over a center post positioned centrally of a ring of phototransistors mounted therein;

FIG. 9 is a perspective overhead view of the center post solar sensor with the ring of phototransistors of FIG. 8; and

FIG. 10 is an enlarged perspective view of the solar sensor of FIG. 8 showing a refracting lens housing.

### DESCRIPTION OF THE PREFERRED EMBODIMENTS

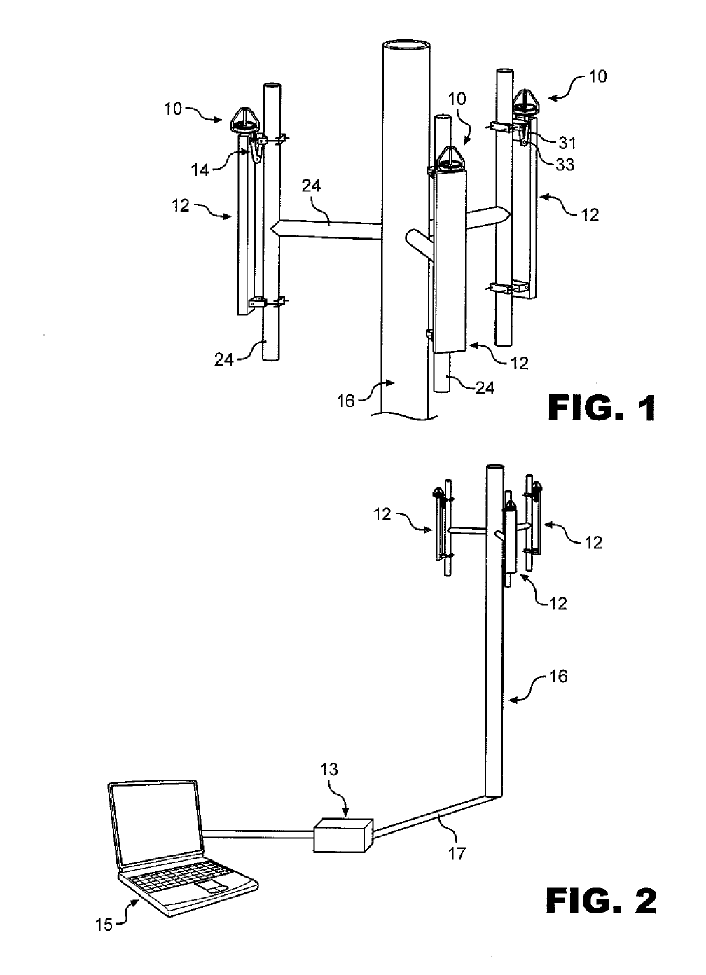

This invention can be configured in several ways depending on the deployment environment. The basic system as shown in FIG. 1 consists of sensors 10 which mount to antennas 12 to be aligned plus a central data collection and processing unit 13, see FIG. 2. Each sensor 10 is mounted to an aligned directional antenna 12, with a known geometric relationship to the directional characteristic of the antenna. This can be a single or multiple segment antenna, as long as there is a common structure that can be used to define alignment of all the segments.

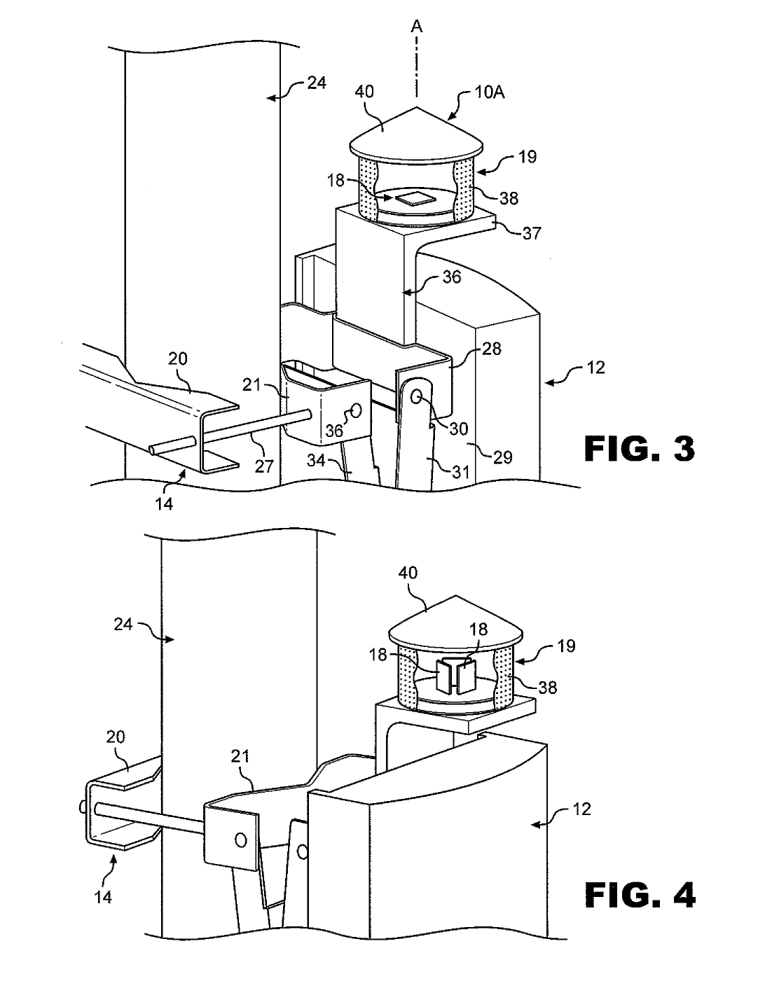

Antennas are typically mounted on some type of adjustable bracket 14, see FIGS. 3, 4 and 8 allowing adjustment in azimuth or heading and downward tilt angle, the angle below horizontal along the antenna's center of energy heading direction. The antennas are also mounted on a tall pole 16 or tower, or on a building or billboard (not shown) overlooking a coverage area. In the embodiment shown, a plurality of antennas are shown mounted to spaced vertically extending pole segments 24 that are carried by support arms 25 that are generally equally spaced outwardly from an upper portion of the tower 16. The number of pole segments may vary with the general idea being that the number of antennas mounted to the tower is sufficient to provide signal coverage through an area of 360° relative to the tower.

Each of the brackets 14 shown includes a pair of clamp members 20 and 21 that are mounted in opposing relationship to one another on opposite sides of one of the pole segments 24 and are secured to one another by adjustable bolts 27. The number of brackets for mounting each antenna may vary from one to any number, however, as shown, two brackets are used to mount the antennas to the pole segments. Each bracket also includes a generally u-shaped member 28 that is secured to the backplane 29 of one of the antennas and which is pivotally connected at spaced points 30 to upper portions of a frame member 31 that is pivotally connected at 33 to spaced lower portions of a second frame member 34 that is pivotally adjustable at points 35 to the clamp member 21. Appropriate fasteners, not shown, are used at each of the pivot points to lock the two frame members in an adjusted position relative to one another in order to retain the mounted antenna in a predetermined and properly aligned position relative to the service area surrounding the tower. By adjusting the angled relationship between the frame portions of each bracket and the clamping members, an appropriate tilt angle may be obtained.

The sensors 10 are also mounted to the backplanes 29 of the antennas by generally L-shaped brackets 36. As shown in FIG. 3, a first sensor 10A is shown mounted on a leg 37 of bracket 36 so as to be positioned at a known and precise relationship to the direction of radiation pattern of the antenna to which it is mounted.

Collection of data can be done at each sensor or at a remote central location. The preferred method is to have one data collection unit 13 for each site having multiple antennas, with the data collection unit accessible at the base of the tower or in an easily accessible control cabinet or room (not shown). Cables 17 or wireless data transmission devices (not shown) connect the sensors to the data collection unit 13. Data reduction and processing can also be done at each sensor 10 as opposed to a remote location of the data collection unit shown in the drawing figures. It is also possible to have the data processing unit include a portable device, such as a standard computer 15, as shown in FIG. 2. In this manner, the collected data may be transferred to the computer or a disk through a direct connection to the sensors or by connection to the data collection unit 13 during a site visit. Information from the data collection unit, the sensors or the computer may also be conveyed over the internet. Software to process the data can be located either on the end users' computer system or on a central internet connected server. Files containing sensor data can be then sent to the server over the internet for processing, and alignment results sent back to the end user. This method allows the software used to process the data to remain in possession of the supplier of the system so that a fee may be collected for each alignment check performed by the end user.

As shown, the alignment sensors are designed to be permanently installed atop of, or otherwise secured relative to, the directional antennas. The sensors can be made using one or a combination of the several ways described herein. The first category of alignment monitoring sensor 10A uses the sun to determine both azimuth and inclination. This is accomplished in one of two main ways. The first way, as shown in FIG. 3 uses a charge coupled device (CCD) as a solar sensor 18 mounted behind a coded aperture or shadow mask 19. The mask is shown in FIGS. 3 and 4 as being partially transparent or translucent for purposes showing the interior CCD, however, the mask will be opaque except for a pattern of small holes provided therein. The mask has a set of very small holes 38 arranged so that light from the sun will project through the holes forming changing patterns of images onto the CCD during certain times of the day. As the earth rotates, the images move in a very precise direction and speed across the CCD. The CCD and coded aperture mask are precisely mounted with respect to the antenna direction, and the relative position of the sun images versus time and date give precise information of both azimuth and elevation (level) of the sensor 10A and therefore the antenna. The shadow mask is designed to have the holes 38 spaced so that any direction that the sun shines through to make an image on the CCD can be distinguished from all others. The top of the sensor 10A is covered by a roof or cover 40 to keep out weather. As previously noted, the bracket 37 interfaces with a part of the antenna at a known precise relationship to the direction of the radiation pattern of the antenna.

The sensor coded aperture mask 19 and CCD 18 can be arranged in several ways, the preferred orientation is with the coded aperture mask 19 in a cylindrical arrangement with a vertical axis “A” and the CCD 18 centered on this axis in a horizontal plane below the shadow mask. The CCD 18 and mask 19 will be arranged to view the sun from about 10 to 60 degrees above the horizontal, and 360 degrees around in azimuth. Alternate versions of this sensor can use the same cylindrical mask with one or more CCD's 18 arranged either vertically as shown in FIG. 4 or at an angle between horizontal and vertical looking up (not shown). This is more complex, but can give a more consistent image of the sun for the change in elevation. Also, the shadow mask 19 can be made planar with the CCD behind it either perpendicular or parallel, or at a compromise angle between facing up towards the mask. This type of mask would have to be oriented toward the rising or setting sun directions, as the field of view in azimuth is somewhat restricted compared to the 360 degree view from the cylindrical mask. In addition to the foregoing, a set of several evenly angularly spaced sensors 10A could be varied so as to may be used to form a 360 degree view sensor as described.

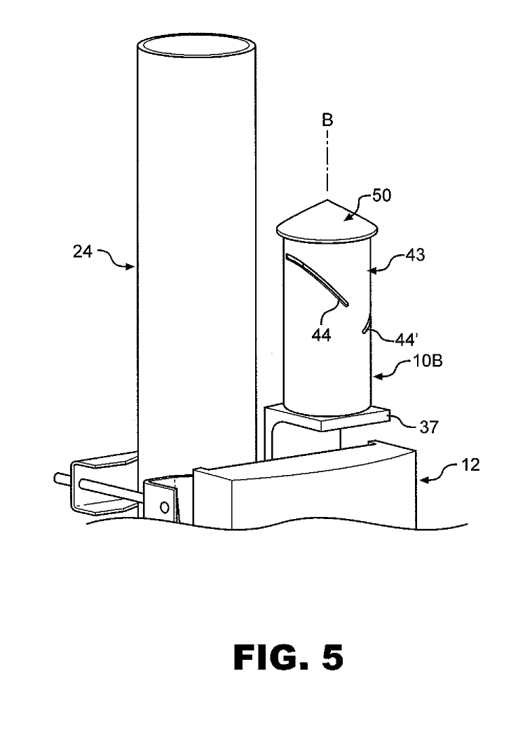

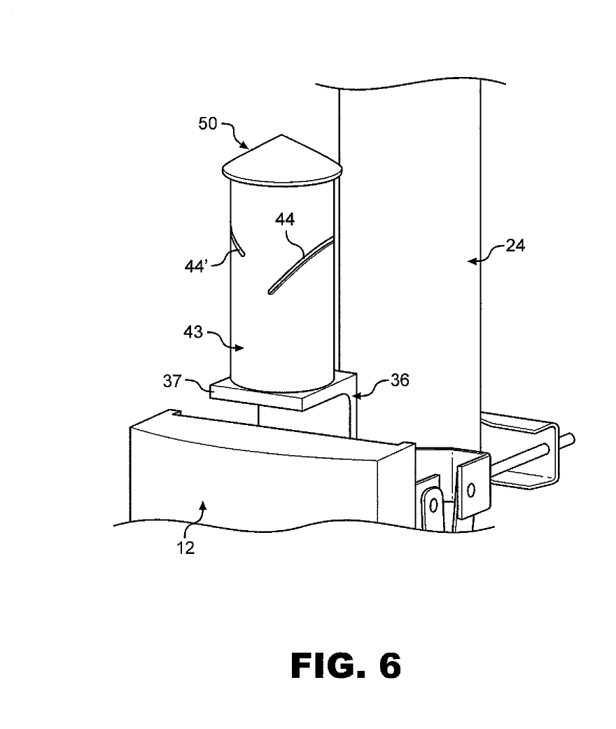

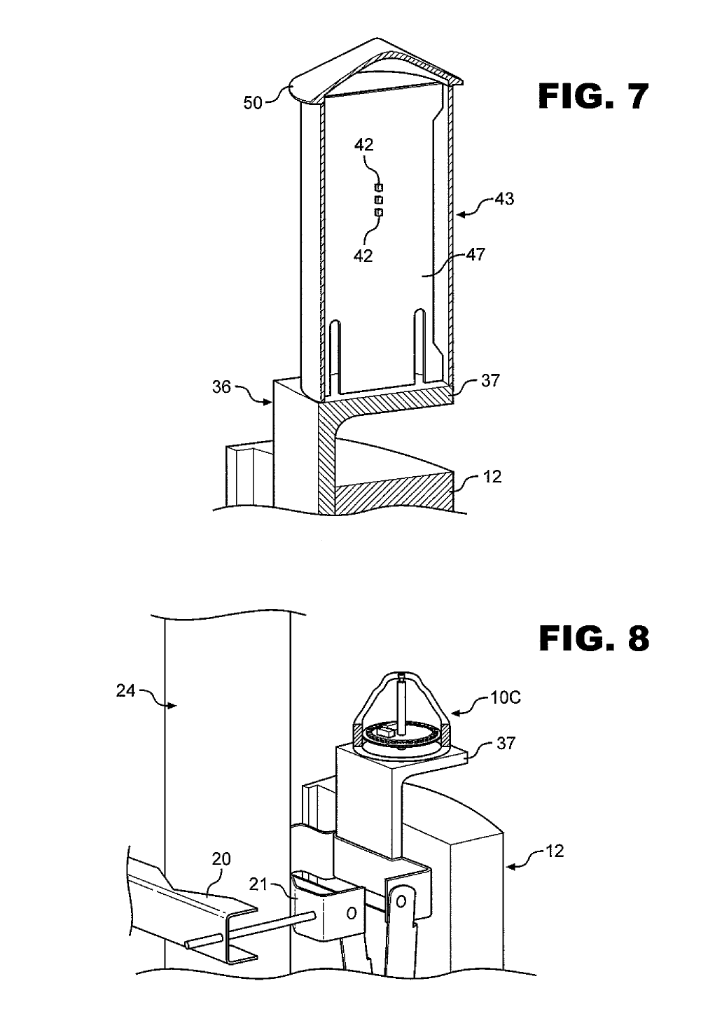

Another variation on the all solar permanently installed alignment monitoring sensor 10B uses a phototransistors or group of phototransistors 42 as solar sensors mounted within a housing 43, see FIG. 7, to sense the sun when it comes into alignment with a set of slits 44, see FIG. 5, in the walls of the housing. The slits 44 are arranged across the possible yearly sun angles for the deployed location of the sensor 10B during the morning and or afternoon. At least one slit for each morning or afternoon is used, or at least two either morning and/or afternoon. Each slit is angled so that the sun crosses it at nearly right angles, within about 30 degrees, each day, and the slits have a wide enough view angle to encompass the variation in sun position from winter to summer. Approximately 90 degrees field of view in the cross sun direction was found to be sufficient for this purpose. The housing 43 prevents light from reaching the phototransistors except through the slits. The housing shape can be hollow cylindrical with a vertical axis “B”, as shown, or of some other configuration.

One phototransistor per slit can be used, or multiple slits can illuminate the same phototransistors, as the times each slit will be illuminated are spaced far enough to not be mistaken. Also, several phototransistors can be aligned below each slit, as is shown in FIG. 7, so that they will be sequentially illuminated as the sun sweeps past each day. This has the advantage of making several measurements per day. The phototransistors can be mounted to a central vertical circuit board 47 or mounted remotely, and connected to the sensor body by fiber optic cables, not shown. The cables would be mounted with their polished ends oriented and placed where the sensors are shown in FIG. 7 to gather the light from the sun when it comes into alignment with each slit. Again, a single sensor is enough for several slits, or each slit can be equipped with a single fiber optic for conveying light to a phototransistors. Plastic molded light conductors, not shown, may also be employed to create a wider angle of light acceptance for the phototransistors either directly or through a fiber optic cable. The threshold value on the phototransistors is set high enough that only direct solar alignment through the slits will activate the sensing circuit.

The housing 43 is mounted atop each antenna to be monitored to be adjustable around the vertical axis, by being secured to an L-shaped bracket, such as 36, as previously described. For this type of sensor, a method of relating the view position of the sensor back to the azimuth direction of the antenna is required. The preferred method is to mount the sensor 10B on the leg 37 of the bracket 36 with the surface of the leg being exactly horizontal when the antenna is correctly leveled, with a central bolt or pin, not shown, about which the sensor can rotate about the vertical axis “B”. To retain the housing in a proper position, a set of equally spaced holes, not shown, are provided on the leg 37 of the sensor mounting bracket 36 into which one or more pins, not shown, on the bottom of the sensor can selectively engage. This forces the sensor to be in one of a number of accepted clocking positions with respect to the antenna. A magnet carried by the mounting bracket 36 may be sensed by one of a circular array of hall effect switches, or reed switches, not shown, arranged around the base of the sensor. Alternately, a fixed pin, not shown, on the mounting bracket 36 can be configured to penetrate one of an array of equally spaced holes, not shown, in the sensor housing 43 base where is it sensed by one of a circular array of optical switches or inductive proximity switches, not shown.

These arrayed sensors relate the azimuth position of the sensor to the position of the antenna. In some instances an engraved degree wheel, not shown, on the bracket 36 can be used as an indicator by a pointer fixed to the sensor housing 43 and the position noted and inputted to the central data collection and processing unit 13. The sensor body is aligned in azimuth to point the slits 44 toward the intended solar track or transverse. For example, a sensor using both morning and afternoon slits would have the slits aligned so that a plane midway between the slits views or faces exactly south. Morning alone slits 44 must be pointed roughly south east, and afternoon alone slits 44′ pointed roughly southwest, depending on latitude. These view directions are to allow installation where the structure of the antenna tower 16 or other support may block some views of the sun. The sensor 10B will not work in a location that is shaded from a direct view of the sun. Measuring of the time of the solar transverse of each slit relative to the known direction of the slits and date, time and location gives precise pointing information of the sensor, in tilt (2 axes) and heading. This is done by comparison of the actual solar transverse time to the expected time from a solar transverse equation and converting the vector to the correct position in the central data collection and processing unit 13.

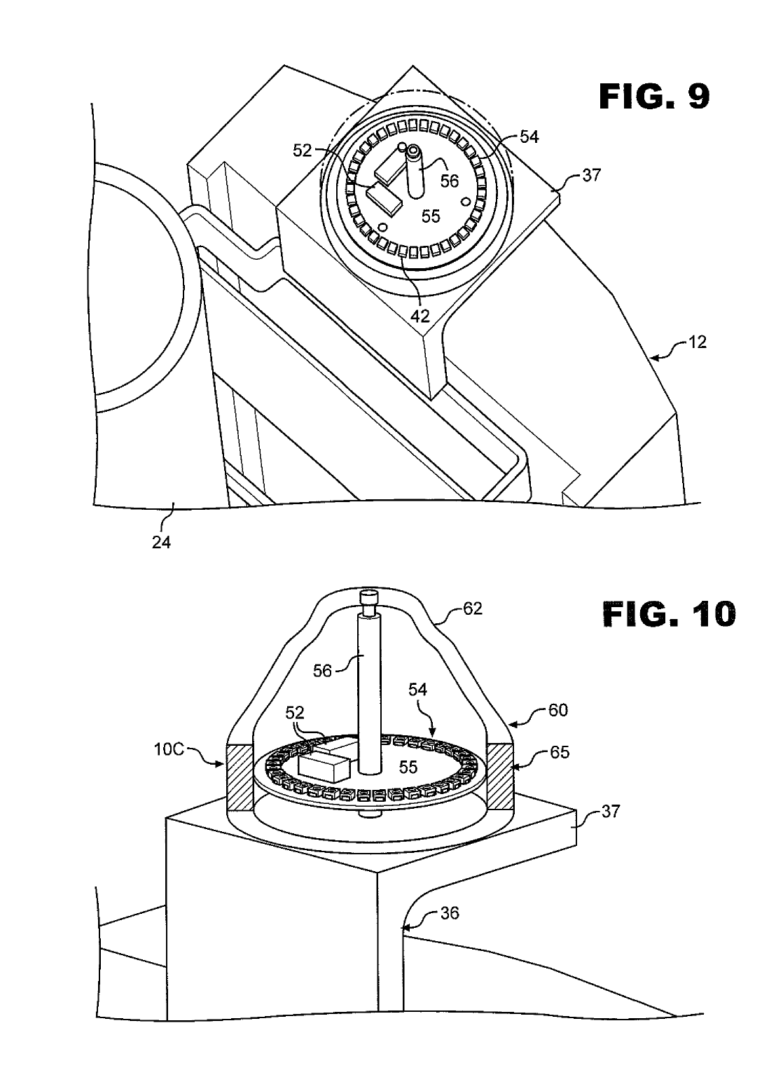

A third embodiment of a permanently installed solar alignment monitoring sensor 10C is shown in FIGS. 8-10 that uses a combination solar sensor for determining azimuth (heading) and electronic level sensors 52 for determining elevation. The sensor 10C is mounted on the horizontal leg 37 of the L-shaped bracket 36 so as to be fixed with respect to the antenna 12. This sensor uses a ring 54 of solar sensors such as phototransistors 42 mounted to the top surface of a horizontally mounted circuit board 55 with a round shadow post 56 mounted vertically in the center of the ring of sensors.

The sun will cast a shadow of the post 56 across the ring of sensors or phototransistors, allowing them to sense the sun azimuth position. This can be done using wide acceptance angle sensors directly, or by placing a cover 60 over the ring of sensors 54 with the cover including a refracting lens 62 positioned above the sensors which accepts sunlight at lower sun angles and refracts the lower incidence sun rays downward into the sensors at a proper acceptance angle. Also, the upward angle can be increased by the same method.

An example of a combination sealed cover and refracting lens 60 is shown in FIGS. 8-10. This combination cover may be made of clear plastic that forms the lens 62 with a lower part 65 of the sealed cover being opaque (not shown) to reduce unwanted sun illumination of the sensors 42. In some of the drawing figures, the cover 60 is shown is dotted line so that the ring of sensors is clearly visible. Further, the lower part 65 is not shown opaque in order to permit visualization of the ring of phototransistors. The number of phototransistors 42, and angular spacing versus the thickness of the shadow post 56 can be selected to create an alternating one sensor shaded, then two. This makes the sun azimuth angle able to be instantly determined using half of the sensor spacing angle. For example, if thirty-six sensors are used with a post that occludes 15 degrees of the arc at the sensor placement radius, the sensor will be able to give an azimuth reading accurate to 5 degrees as soon as the sun is visible to the sensors. Upon the shadow edge crossing one of the phototransistors, the angular precision increases to the practical limit given by the accuracy of sensor threshold setting plus time keeping and geographic location of the sensor 10C.

Level sensing in the current embodiment may be handled instantly by either a pair of electronic level sensors using a pendulum (not shown) or by a pair of solid state accelerometers 52. In either case, the instruments are placed orthogonally with one axis aligned with down tilt angle of the antenna. It should be noted that the electronic lever sensors 52 may be of any convention structure such that level readings may be transmitted directly or indirectly to the data collection and processing unit 13.

The sensor 10C has two distinct advantages to the sensor 10B discussed above. First, it can be installed in any azimuth orientation, making alignment to the antenna much simpler, as it will be fixed to the antenna in one orientation regardless of the antenna's installed direction (N, S, E or W). Second, the level information is available to the installed real time, and may be used to assist with antenna alignment during installation regardless of weather conditions. Level information from all the sensors gives information in two axes, down tilt, along the antenna's preferential radiation direction, and roll, perpendicular to the antenna's preferential radiation direction. Down tilt is the most important parameter to an antenna's performance, but roll information is also important, because the antenna's mapped radiation pattern assumes that the antenna is mounted level in roll.

It should be noted that the sensors 10A and 10B describe herein could also be fitted with electronic level sensors to gain the advantages stated above. It should also be noted that other solar sensing devices may be used with or in place of the CCD devices and phototransistors mentioned in the described embodiments.

The foregoing description of the present invention has been presented to illustrate the principles of the invention and not to limit the invention to the particular embodiments illustrated. It is intended that the scope of the invention be defined by all of the embodiments encompassed within the following claims and their equivalents.

We claim:

1. A sensor for use in determining an alignment of a directional or omni-directional antenna with respect to tilt angle of the antenna relative to a horizontal plane and a directional heading thereof wherein the antenna is mounted at a vertically elevated location, the sensor comprising, a housing, means for mounting the housing to the antenna, at least one solar sensing element mounted within the housing, said at least one solar sensing element generating an output signal in response to solar energy radiating a portion of a surface thereof, means for communicating the output signal with a data processing unit, and the housing including means for controlling the passage of solar radiation entering the housing toward the at least one solar sensing element such that the solar radiation being sensed by the at least one solar sensor may be used to calculate at least one of an azimuth and a tilt angle of the antenna.

2. The sensor of claim 1 wherein the at least one solar sensing element includes a CCD.

3. The sensor of claim 1 wherein the housing is generally opaque and includes a plurality of openings there through by way of which solar energy enters the housing toward the at least one solar sensing element, and the openings being placed in predetermined positions such that relative positions of solar images impinging on the at least one solar sensing element may be compared with a date and time of day to thereby provide alignment data of the antenna.

4. The sensor of claim 3 including a plurality of solar sensing elements mounted within the housing.

5. The sensor of claim 4 wherein the plurality of solar sensing elements are at least partially vertically oriented within the housing.

6. The sensor of claim 3 wherein the housing is cylindrical having a central vertical axis and the at least one solar sensing element being centered with respect to the vertical axis and being positioned below the openings within the housing.

7. The sensor of claim 1 wherein the at least one solar sensing element includes at least one phototransistor.

8. The sensor of claim 1 wherein the housing is structured to prevent light from entering the housing except through at least one slit therein through with solar energy may pass toward the at least one solar sensing element.

9. The sensor of claim 8 wherein the housing includes at least two spaced slits therein wherein a first slit is positioned to permit morning solar energy to enter the housing and a second is positioned to permit afternoon solar energy to enter the housing.

10. The sensor of claim 9 including at least one solar sensing element associated with each of the first and second slits.

11. The sensor of claim 8 wherein the at least one slit extends in a vertically diagonal direction.

12. The sensor of claim 11 including means for communicating solar energy passing through the at least one slit to the at least one solar sensing element.

13. The sensor of claim 1 wherein the at least one solar sensing element includes a plurality of spaced solar sensing elements that are positioned relative to a shadow creating member mounted within the housing such that shadow images on the spaced solar sensing elements may be used to determine an azimuth position of the sun.

14. The sensor of claim 13 wherein at least a portion of the housing is transparent to permit sun light to pass there through toward the plurality of spaced solar sensing elements.

15. The sensor of claim 14 in which a portion of the housing that is transparent forms a refracting lens that directs solar energy toward the plurality of solar sensing elements.

16. The sensor of claim 15 wherein the plurality of solar sensing elements are mounted in a circular array with the shadow creating member being positioned centrally of the circular array.

17. The sensor of claim 13 including at least one electrical level sensing device for determining a level of the antenna.

18. The sensor of claim 8 including at least one electrical level sensing device for determining a level of the antenna.

19. The sensor of claim 1 including at least one electrical level sensing device for determining a level of the antenna.

20. An apparatus for use for determining an alignment of a directional or omni-directional antenna with respect to at least one of a tilt angle and heading of the antenna, comprising means for adjustably mounting the antenna at a vertically elevated location, a sensor for use in determining an alignment of the antenna with respect to at least one of a tilt angle of the antenna relative to a horizontal plane and a directional heading thereof, the sensor including a housing, means for mounting the housing to the antenna, at least one solar sensing element mounted within the housing, said at least one solar sensing element generating an output signal in response to solar energy imaging a surface portions thereof, means for communicating the output signal with a data processing unit, and the housing including means for controlling the passage of solar radiation entering the housing toward the at least one solar sensing element such that the solar imaging being sensed by the at least one solar sensor may be used to calculate at least one of an azimuth and tilt angle of the antenna.
